(19) United States
(12) Patent Application Publication
(10) Pub. No.: US 2006/0134962 A1
(43) Pub. Date: Jun. 22, 2006

(54) Protection device for USB connector

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/014,171

(22) Filed: Dec. 17, 2004

(51) Int. Cl. H01R 13/627

(52) U.S. Cl. 439/352

(57) ABSTRACT

A protection device for a USB connector is disclosed. A first fastener structure is mounted on a USB female socket (or a USB male plug) and a second fastener structure is mounted on the USB male plug (or the USB female socket) for cooperating with the USB female socket (or the USB male plug) thereby providing the USB connector with the protection function. The USB connector will not be disassembled when it suffers from the external force.

### FIELD OF THE INVENTION

The present invention relates to a protection device to provide the USB connector with the protection function and prevent the USB connector from being disassembled when it suffers from collision or twitch. This protection device for the USB connector is suitable for various jointers, connectors, adapters, cables of related apparatuses or the like.

### BACKGROUND OF THE INVENTION

It is commonly seen that many computers and peripheral apparatuses, such as scanners, digital cameras, removable hard disks, etc, introduce the Universal Serial Bus (USB) specification into the connection interface of a transmission connector. The USB connector provides with the advantage of unifying various connectors that have various specifications so as to overcome the conventional drawback of providing a specific connector for a specific apparatus. The USB connector has been integrated various functions of various connectors with one another. Therefore, transmission speed, installation, and maintenance of the USB connector are superior to that of the conventional singular connector that provides the connection interface, for example, COM 1, COM 2, LPT, etc.

Although the conventional USB connector is convenient to use, during the assemblage operation between the female socket A and the male plug B, the frame A2 mounted on the outer fringe of the terminal base A1 of the female socket A limits the position of the terminal base (not shown) and the outer frame B2 of the male plug B so as to transmit signal, as shown in FIG. 1. If the assembled USB connector is not knocked, it provides with excellent transmission effect. However, if the USB connector is knocked or plucked accidentally, it is easily disassembled into a female socket and a male plug since the conventional USB structure provides with no protection structure to protect itself from being disassembled.

In view of the major drawback of this USB connector, the present inventor has been made diligent studies with a quiet mind to provide a protection device to prevent the USB connector from being disassembled when it suffers from the external force. This protection device for the USB connector is provided for the consumer in accordance with motivations of the present invention.

### SUMMARY OF THE INVENTION

The main object of the present invention is to disclose a protection device for a USB connector for providing the USB connector with the protection function thereby preventing the USB connector from being disassembled when it suffers from the external force.

Another object of the present invention is to provide a protection device for the USB connector that prevents its transmission effect from being affected by twitch.

In view of the aforementioned objects, the present invention disposes a first fastener structure on a USB female socket (or a USB male plug) and a second fastener structure that cooperates with the USB female socket (or the USB male plug) on the USB male plug (or the USB female socket) so as to provide the USB connector with the protection function. This USB connector will not be disassembled when it suffers from the external force.

The other features and preferred embodiments of the present invention will now be described with reference to the accompanying drawings.

### BRIEF DESCRIPTION OF THE DRAWINGS

FIG. 1 is an elevational view showing the outward appearance of a conventional USB connector.

FIG. 2 is an elevational view showing the outward appearance of a first preferred embodiment of the present invention.

FIG. 3 through FIG. 4 are cross-sectional views showing the assemblage operation of the first preferred embodiment of the present invention.

FIG. 5 is an elevational view showing the outward appearance of a second preferred embodiment of the present invention.

FIG. 6 is an elevational view showing the outward appearance of a third preferred embodiment of the present invention.

### DETAILED DESCRIPTION OF THE PREFERRED EMBODIMENT

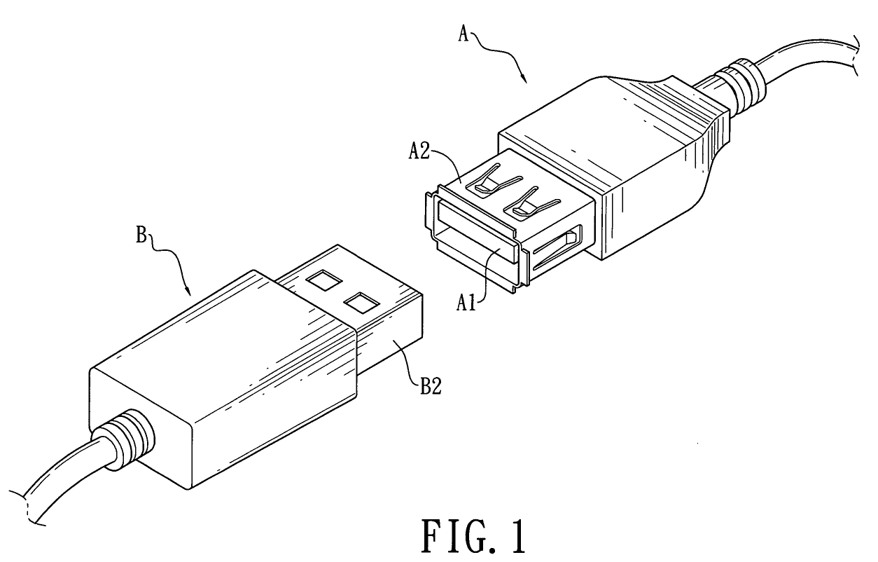

FIG. 1 is an elevational view showing the outward appearance of a conventional USB connector. The structure of the conventional USB connector, which has been described above, is omitted herein.

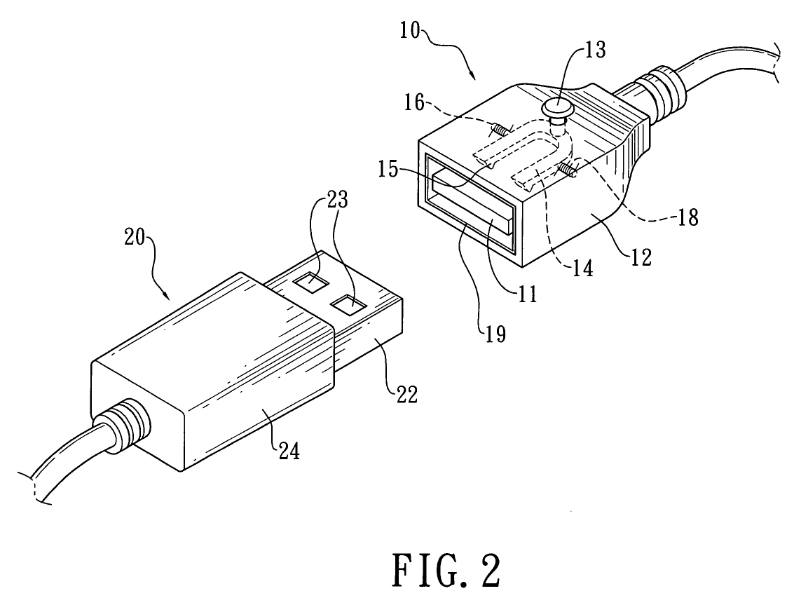

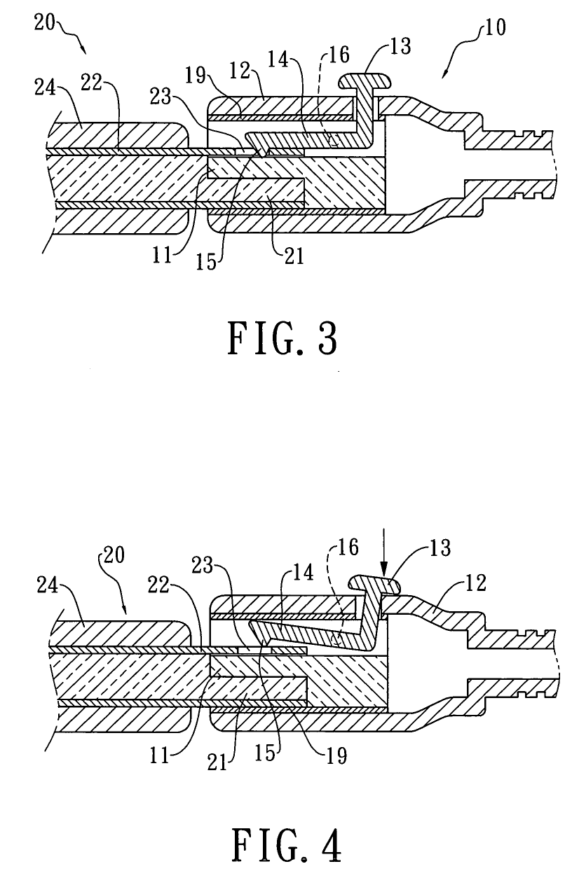

FIG. 2 and FIG. 3 illustrate a first preferred embodiment of a female socket 10 and a male plug 20 designed in accordance with the present invention. The female socket 10 includes a terminal base 11, which is covered with an insulating frame 19 and a plastic outer frame 12. A perforation for holding a button 13 is formed on the top portion (or the bottom portion) of the insulating frame 19 and the plastic outer frame 12, wherein the bottom portion of the button 13 is connected to a U-shaped lamina 14. A hook 15 is mounted respectively on each end of the U-shaped lamina 14 and a stationary shaft 16 is mounted respectively on the medium portion of the U-shaped lamina 14 to extend from both outer surfaces thereof. Each stationary shaft 16 holds a limit spring 18 respectively to enable the hook 15 that mounts on each end of the U-shaped lamina 14 to lean against and parallel to the terminal base 11. Consequently, a complete first fastener structure is constituted.

The male plug 20 and the conventional male plug are identical in structure. The male plug 20 primarily comprises a terminal base 21, which is covered with an insulating frame 22 having two fixing holes 23 formed thereon, such that a second fastener structure that corresponds to the first fastener structure of the female socket 10 is constituted, wherein a plastic outer frame 24 covers the later half of the terminal base 21 and the insulating frame 22.

Referring to FIG. 3 again, in order to assemble the male plug 20 and the female socket 10, the exposed insulating frame 22 of the male plug 20 is inserted directly into the opening of the plastic outer frame 12 of the female socket 10. At this moment, the front end of the insulating frame 22 progresses along the gradient of the hooks 15 and lifts them up by means of the elastic force of the limit spring 18. The insertion force of the insulating frame 22 enables the hooks 15 to slide along the surface of the insulating frame 22 until the bottom end of the insulating frame is reached so as to lock the hooks 15 mounted on the U-shaped lamina 14 by use of the fixing holes 23 formed on the insulating frame 22 for assembling the fastener structures of the female socket 10 and the male plug 20 and connecting the terminal base 11 and the terminal base 21 with one another. As described above, the assemblage of the USB connection is accomplished.

On the basis of the aforementioned description, since the fasteners of the male plug 20 and the female socket 10 are locked with one another by use of the hook 15 that mounts on the front end of the U-shaped lamina 14 inside the female socket 10 to lock the fixing hole 23 that forms on the insulating frame 22 of the male plug 20), they will not be separated from one another even if the assembled USB connector is knocked or plucked. Therefore, the pull force that applies to the wire of the USB connector will not cause the male plug 20 and the female socket 10 to separate from one another. Accordingly, the USB connector is provided with the protection effect.

When it is desired to separate the USB connector into the female socket 10 and the male plug 20, as shown in FIG. 4, once the button 13 is pressed, the hook 15 mounted on the front end of the U-shaped lamina 14 is raised and the fixing hole 23 is not locked by the hook 15 any more since the stationary shaft 16 fixed in the plastic outer frame 12 forms a rotation shaft.

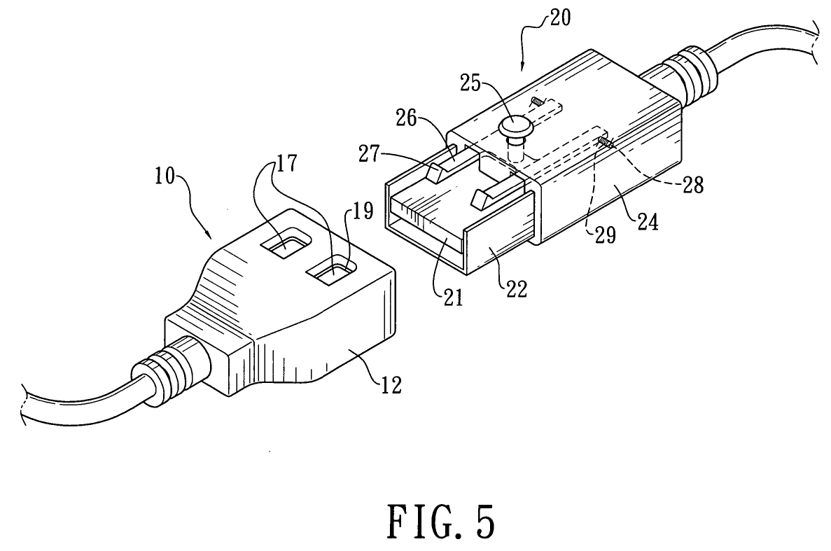

FIG. 5 illustrates a second preferred embodiment of a female socket 10 and a male plug 20 designed in accordance with the present invention. The female socket 10 comprises a terminal base (not shown) mounted therein; and an insulating frame 19 and a plastic outer frame 12 covered the terminal base, wherein two fixing holes that penetrate through the female socket 10 are mounted on the top portion thereof so as to constitute a first fastener structure. A terminal base 21 is mounted on the male plug 20 and the terminal base 21 is posited on the medium and upper portions of a U-shaped insulating frame 22 by which the terminal base 21 is covered. A plastic outer frame 24 covers the rear areas of the insulating frame 22 and the terminal base 21. A perforation is formed on the plastic outer frame 24 for holding a button 25. A H-shaped lamina 26 having two parallel arms is connected to the bottom portion of the button 25. An upwardly extending hook 27 is mounted respectively on each front end of two parallel arms of the H-shaped lamina 26. A stationary shaft 28 is mounted respectively on the outside of the rear ends of the parallel arms of the H-shaped lamina 26. Each stationary shaft 28 holds a limit spring 29 and connects to the plastic outer frame 24 to enable the H-shaped lamina 26 to lean against the plastic outer frame 24 in normal condition. Accordingly, the second fastener structure is constituted.

In order to assemble the male plug 20 and the female socket 10, the exposed insulating frame 22 and the terminal base 21 of the male plug 20 are inserted directly into the opening of the female socket 10 until the hooks 27 mounted on the front ends of the H-shaped lamina 26 touch the opening of the female socket 10. Next, the opening of the female socket 10 is forced to progress along the gradient of the hooks 27 and apply an indirect force to the H-shaped lamina 26 until the bottom portion of the female socket 10 is reached so as to enable the hooks 27 mounted on the front ends of the H-shaped lamina 26 to exactly enter the fixing holes 17 of the female socket 10 for assembling these two fastener structures. Accordingly, the hooks 27, which lock the fixing holes 17, protect the USB connector from being disassembled when the wire of the USB connector suffers from twitch accidentally. If this USB connector is to be disassembled into the female socket 10 and the male plug 20, the H-shaped lamina 26 is forced down for raising the hooks 27 by pressing the button 25 since the stationary shaft 28 fixed in the plastic outer frame 24 forms a rotation shaft such that the fixing holes 23 are not locked by the hooks 27 any more. Accordingly, the male plug 20 and the female socket 10 can be easily separated from one another by forcing the female socket 10 to backwardly eject from the male plug 20.

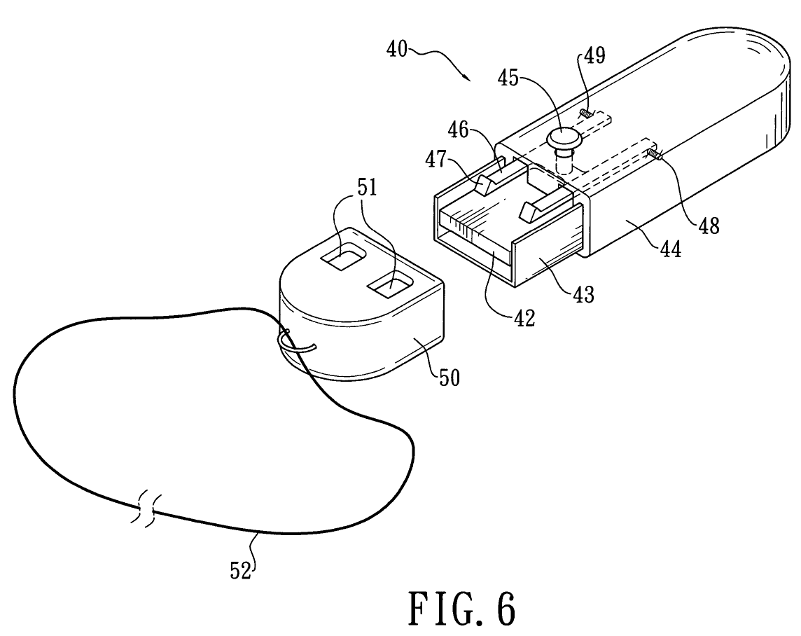

Because of their small dimensions, the popular MP3 players or portable disks nowadays are usually hung on the neck via a necklace to prevent them from loss. As shown in FIG. 6, a terminal base 42 is mounted on a connector of the portable disk 40 and covered with a U-shaped insulating frame 43. The rear areas of the insulating frame 43 and the terminal base 42 are covered with a plastic outer frame 44 on which a perforation is formed for holding a button 45. A H-shaped lamina 46 having two parallel arms is connected to the bottom portion of the button 45. An upwardly extending hook 47 is mounted respectively on the front ends of two parallel arms of the H-shaped lamina 46. A stationary shaft 48 is mounted respectively on the outside of the rear ends of the parallel arms of the H-shaped lamina 46. Each stationary shaft 48 holds a limit spring 49 and connects to the plastic outer frame 44 thereby forming a first fastener structure. A protection cover 50 covers the connector of the portable disk 40. A fixing hole 51 (i.e., a second fastener structure) that corresponds to the hook 47 is formed on the protection cover 50 for locking the hook 47. Moreover, a necklace 52 is mounted directly on the rear area of the protection cover 50. Accordingly, the portable disk 40 is further provided with protection and the operation for demounting the protection cover 50 is simplified.

However, the aforementioned description merely illustrates the preferred embodiments of the present invention, and the applicable scope of the present invention is not limited hereto. Any obvious modification and revision made by a person skilled in the art are included within the spirit and scope of the present invention.

As described above, the present invention is able to achieve the expected purposes of the present invention by providing a protection device for USB connector to protect the USB connector and prevent the USB connector from being disassembled when it suffers from collision or twitch. The application that complies with utility is therefore submitted for a patent.

What the invention claimed is:

1. A protection device for a USB connector on which a first fastener structure is mounted on a female socket (or a male plug) and a second fastener structure that corresponds to the first fastener structure is mounted on the male plug (or the female socket) for cooperating with the female socket (or the male plug) thereby providing the USB connector with the protection function to prevent it from being disassembled when it suffers from the external force.

2. The protection device for a USB connector of claim 1, wherein the first fastener structure is mounted on the female socket of the USB connector, a perforation being mounted on the female socket for holding a button, a lamina having a hook on the front end thereof being connected to the bottom portion of the button, a stationary shaft which holds a limit spring being extended from the medium and rear portions and mounted on both outsides of the lamina for connecting with a plastic outer frame of the female socket so as to enable the lamina to lean against the plastic outer frame of the terminal base in normal condition, wherein the male plug is a conventional male plug and the second fastener structure is a fixing hole formed on an insulating frame.

3. The protection device for a USB connector of claim 2, wherein the lamina connected to the bottom of the button of the female socket is a U-shaped lamina having two parallel arms.

4. The protection device for a USB connector of claim 3, wherein a connection part of the lamina is connected to the button and the hook is disposed on the front end of the lamina to face downwardly.

5. The protection device for a USB connector of claim 2, wherein a connection part of the lamina is connected to the button and the hook is disposed on the front end of the lamina to face downwardly.

6. The protection device for a USB connector of claim 1, wherein the second fastener structure is mounted on the male plug, a terminal base, an insulating frame, a lamina being mounted inside the second fastener structure and covered with an plastic outer frame, the insulating frame comprising an opening on the top portion thereof, the terminal base being mounted on the medium and top portions of the insulating frame, the lamina being mounted on the top portion of the terminal base, a hook being mounted on the front end of the lamina, a stationary shaft having a limit spring being connected with a plastic outer frame, a perforation being formed on the top surface of the plastic outer frame for holding a button, the bottom portion of the button being connected to the lamina, wherein a fixing hole is formed on the top portion of the first fastener structure of the female socket.

7. The protection device for a USB connector of claim 6, wherein the lamina is a H-shaped lamina, the rear area of the H-shaped lamina being connected to the plastic outer frame through the stationary shaft, a connection part that mounts on the center portion of the H-shaped lamina being connected to the button, the hook being disposed on the front end of lamina to face downwardly.

8. The protection device for a USB connector of claim 7, wherein the number of the fixing hole formed on the female socket matches to the number of the hook mounted on the lamina.

9. The protection device for a USB connector of claim 6, wherein the number of the fixing hole formed on the female socket matches with the number of the hook mounted on the lamina.

10. The protection device for a USB connector of claim 6, wherein the distance between the lamina and the terminal base is larger than the extended height of the hook.
